(19) United States
(12) Patent Application Publication
(10) Pub. No.: US 2014/0054242 A1
(43) Pub. Date: Feb. 27, 2014

(54) LIQUID TREATING APPARATUS AND LIQUID TREATING METHOD

(71) Applicant: Shin-ichi Imai, Osaka (JP)

(72) Inventor: Shin-ichi Imai, Osaka (JP)

(73) Assignee: PANASONIC CORPORATION, Osaka (JP)

(21) Appl. No.: 14/113,370

(22) PCT Filed: Dec. 26, 2011
(86) PCT No.: PCT/JP2011/007272

§ 371 Date: Oct. 22, 2013

(30) Foreign Application Priority Data
May 17, 2011 (JP) 2011-110169

(51) Int. Cl. C02F 1/46; B01J 19/08

(52) U.S. Cl. CPC C02F 1/4608; B01J 19/088
USPC 210/748.17; 210/150

(57) ABSTRACT

A plasma-generating apparatus includes a first electrode of which at least a part is positioned within a treatment vessel that is to contain liquid, a second electrode of which at least a part is positioned within the treatment vessel, a bubble-generating part which generate a bubble when the liquid is contained in the treatment vessel, such that a surface where conductor is exposed, of a surface of the first electrode which surface is positioned within the treatment vessel, is positioned within the bubble, a gas-supplying apparatus, a power supply for applying voltage between the first electrode and the second electrode.

### TECHNICAL FIELD

The present invention is related to a liquid-treating apparatus which treats to-be-treated liquid electrochemically, in particular a liquid-treating apparatus which treats the liquid by generating plasma.

### BACKGROUND ART

A conventional liquid-treating apparatus using a high-voltage pulse discharge is described in, for example, Patent Document 1. FIG. 10 shows a configuration view of a conventional sterilizing apparatus described in JP 2009-255027 A.

The sterilizing apparatus 1 shown in FIG. 10 comprises a discharge electrode 6 including a pair of a columnar high-voltage electrode 2 and a plate-shaped ground electrode 3. The high-voltage electrode 2 is covered with insulator 4 except for an end face of a tip portion 2a, to form a high-voltage electrode portion 5. The tip portion 2a of the high-voltage electrode 2 and the ground electrode 3 are opposed to each other with a predetermined gap, being immersed in to-be-treated water 8 within a treatment vessel 7. The high-voltage electrode 2 and the ground electrode 3 are connected to a power supply 9 which generates high-voltage pulses. The discharge is made by applying negative high-voltage pulses of 2 kV/cm to 50 kV/cm and 100 Hz to 20 kHz between both electrodes. Bubbles 10 of steam and a jet flow 11 caused by bubbles 10 are generated by evaporation of water with energy of discharge and vaporization involved by a shock wave and a jet flow 11 is generated by the bubbles 10. Plasma generated around the high-voltage electrode 2 generates OH, H, O, O₂⁻, O⁻, and H₂O₂ to destroy microorganism and bacteria.

Similarly, Patent Document 6 A proposes a method for purifying liquid wherein the liquid is boiled and vaporized to form bubbles and the vaporized substance (generate plasma) is ionized within the bubbles to form ions and the ion species in the plasma are penetrated and diffused in the liquid. Patent Document 6 describes that, in order to generate plasma, high-voltage pulses having a maximum voltage of about 1 kV to 50 kV, repeated frequencies of 1 kHz to 100 kHz and a duration of 1 μs to 20 μs, are applied to an electrode pair of high-voltage electrodes.

Another conventional liquid-treating apparatus is described in Patent Document 2. Patent Document 2 discloses that a liquid-treating apparatus described in this document can reduce an applied voltage by interposing bubbles, which are supplied from outside, between electrodes in liquid, whereby power consumption can be reduced. Similar techniques are disclosed in Patent Documents 3, 4, and 5.

### PRIOR ARTS DOCUMENTS

### Patent Literatures

Patent Document 1: JP 2009-255027 A

Patent Document 2: JP 2000-93967 A

Patent Document 3: JP 2003-62579 A

Patent Document 4: JP 2010-523326 A

Patent Document 5: JP 3983282 B

Patent Document 6: JP 2007-207540 A

### SUMMARY OF INVENTION

### Problem Solved by the Invention

However, there was a problem that generation efficiency of plasma was low in the above-described conventional apparatuses, requiring a long time of period for treating liquid. Further, when the plasma is generated in bubbles formed by vaporization of the liquid, it is necessary to input high electrical power to vaporize the liquid since the electrical power was lost in the liquid, which requires a large-scale power supplying apparatus. Specifically, the power supplying apparatus is required to have ability of supplying electricity power of 4000 W or more in order to vaporize water, considering the loss.

The present invention solves the problem and provides a liquid-treating apparatus and a liquid-treating method which enable liquid to be treated in a short period of time and/or with a low power by efficient plasma generation.

### Means to Solve the Problem

A liquid-treating apparatus of the present invention includes:

a first electrode of which at least a part is placed in a treatment vessel that is to contain liquid,

a second electrode of which at least a part is placed in the treatment vessel,

a bubble-generating part which generates a bubble in the liquid when the liquid is contained in the treatment vessel, such that at least surface where conductor is exposed, of a surface of the first electrode which surface is positioned in the treatment vessel, is positioned within the bubble,

a gas-supplying apparatus which supplies gas in an amount necessary for the bubble generation from the outside of the treatment vessel, and

a power supply which applies voltage between the first electrode and the second electrode.

A plasma-generating method of the present invention includes:

applying voltage between a first electrode and a second electrode using a power supply, at least a part of the first electrode being positioned in liquid contained in a treatment vessel and at least a part of the second electrode being positioned in the liquid, and

supplying gas to a bubble-generating part positioned in the liquid to generate a bubble in the liquid,

wherein the bubble is generated such that at least surface where conductor is exposed, of a surface of the first electrode which surface is positioned in the liquid, is positioned within the bubble, and

plasma is generated within the bubble by the application of voltage.

### Effect of the Invention

The present invention enables plasma to be generated efficiently and thereby enables the liquid to be treated with low power and/or in a short period of time.

### BRIEF DESCRIPTION OF DRAWINGS

FIG. 1 is a configuration view of a liquid-treating apparatus in a first embodiment of the present invention.

FIG. 1-2 is a sectional side view wherein vicinity of an opening portion of an electrode in the first embodiment is enlarged of the present invention.

FIG. 1-3 is a photograph showing bubbles generated in the first embodiment of the present invention.

FIG. 2 is a graph showing spectral characteristics of plasma generated in the first embodiment of the present invention.

FIG. 3 is a graph showing change over time in transmittance of an aqueous indigocarmine solution in the first embodiment of the present invention.

FIG. 4 is a configuration view of a liquid-treating apparatus in a second embodiment of the present invention.

FIG. 4-2 is a sectional side view wherein vicinity of an opening portion of an electrode in the second embodiment is enlarged of the present invention.

FIG. 4-3 is a photograph showing bubbles generated in the second embodiment of the present invention.

FIG. 5 is a graph showing relationship between complete decolorization time of an aqueous indigocarmine solution and a distance between an end face of insulator and an end face of the second electrode in the second embodiment of the present invention.

FIG. 6 is a configuration view of a liquid-treating apparatus in a third embodiment of the present invention.

FIG. 7 is a graph showing change over time in transmittance of the aqueous indigocarmine solution in the third embodiment of the present invention.

FIG. 7-2 is a graph showing relationship between complete decolorization time of the aqueous indigocarmine solution and the distance between the end face of the insulator and the end face of the second electrode in the third embodiment of the present invention.

FIG. 7-3 is a photograph showing bubbles generated in the third embodiment of the present invention.

FIG. 8 is a graph showing spectral characteristics of plasma generated in the third embodiment of the present invention.

FIG. 9 is a graph showing change over time in transmittance of the aqueous indigocarmine solution in the first embodiment when power is varied of the present invention.

FIG. 10 is a configuration view of a conventional waste water treatment apparatus using high-voltage pulse discharge.

### EMBODIMENTS OF THE INVENTION

Embodiments of the present invention will be described with reference to the drawings.

### First Embodiment

### [Overall Configuration]

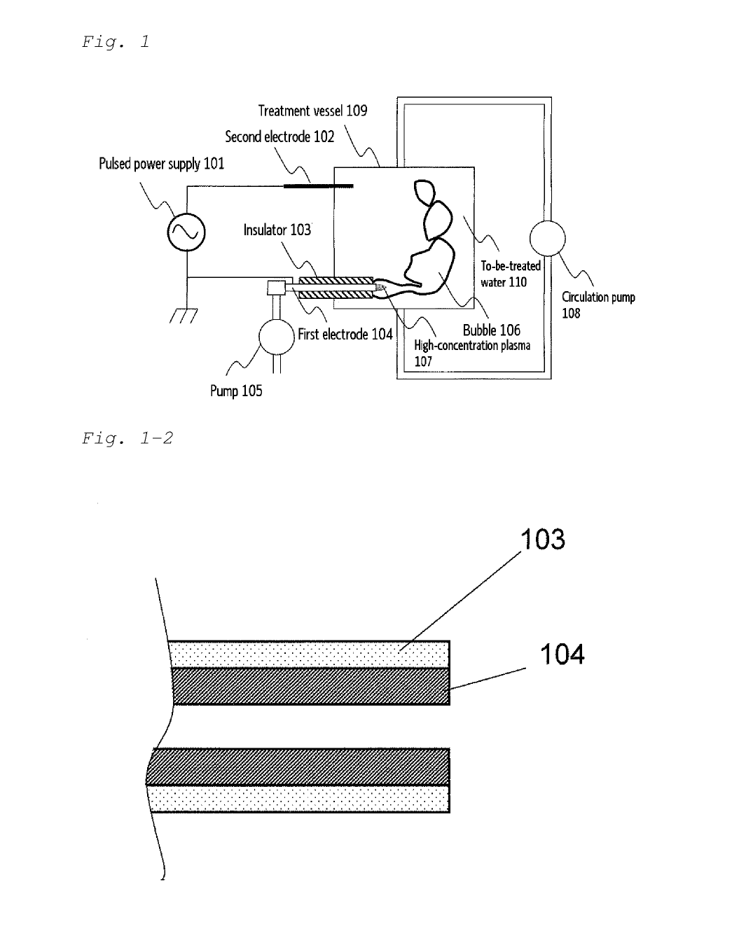

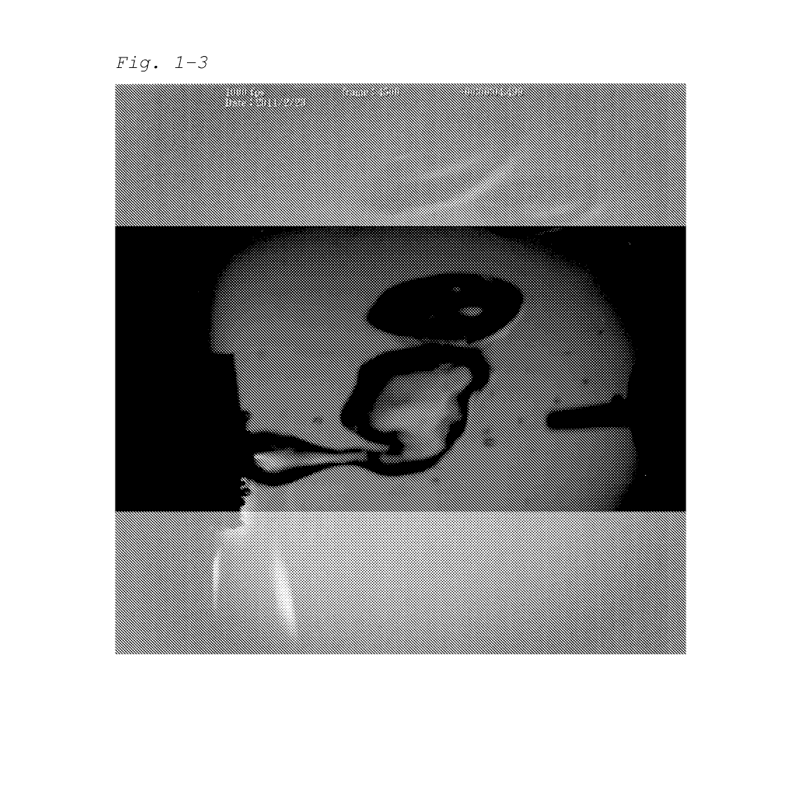

FIG. 1 is a diagram showing the overall configuration of a liquid-treating apparatus according to the present embodiment.

In FIG. 1, the treatment vessel 109 is filled with water as the liquid to be treated (to-be-treated water) 110. The treatment vessel 109 has capacity of about 250 milliliters (about 250 cm³). In one of the walls of the treatment vessel 109, a second electrode 102 and a first electrode 104 which pass through the wall, are disposed and one end of each electrode is disposed within the treatment vessel 109. The first electrode 104 has a tubular shape of which both ends are opened (more specifically a cylindrical shape), and an opening portion at one end is connected to a pump 105 as a gas-supplying apparatus. A gas is supplied through the opening portion at the other end of the first electrode 104 into the treatment vessel 109 by the pump 105. The gas supplied from the outside of the treatment vessel 109 is air, He, Ar, O₂ or the like. The gas is supplied from a gas-supplying source (not shown) which is provided separately or atmosphere gas in which the treatment vessel 109 is placed is supplied as it is. The second electrode 102 is columnar, and is placed such that one end contacts the to-be-treated water 110 in the treatment vessel 9. A pulsed voltage or an alternating voltage is applied between the second electrode 102 and the first electrode 104 by the power supply 101. Further, the to-be-treated water 110 is circulated by a circulation pump 108. A circulation speed of the to-be-treated water 110 is set at an appropriate value based on a decomposition speed of a material to be decomposed by plasma and a capacity of the treatment vessel 109.

A dimension of the treatment vessel 109 is not limited particularly. For example, the dimension of the treatment vessel 109 may be one having a capacity of 0.1 liters to 1000 liters.

In case where the liquid-treating apparatus is incorporated in a household appliance, the volume of a unit consisting of the power supply and the pump is preferably 1000 cm³ to 5000 cm³. Such a volume is preferably obtained by designing a cubic of which length×width×height is 100 mm×100 mm×100 mm to 171 mm×171 mm×171 mm. Alternatively, the unit consisting of the power supply and the pump may be of rectangular parallelepiped or another shape. When the dimension (that is, the volume) of the unit consisting of the power supply and the pump which is included in the liquid-treating apparatus is too large in the household appliance, the household appliance itself becomes large. Since the liquid-treating apparatus of the present invention can generate plasma efficiently, the liquid can be treated with the power supply which is small enough to be received by the unit of the above volume.

### [Electrode Configuration]

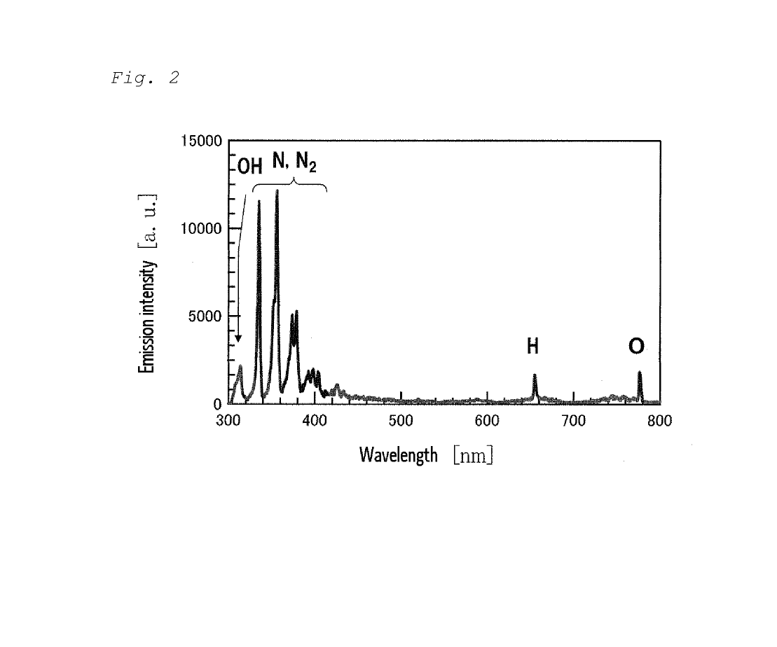

FIG. 1-2 is a sectional side view showing an enlarged vicinity of the opening portion of the first electrode 104. The first electrode 104 is a cylindrical electrode of a metal and has an inner diameter of 0.4 mm and an outer diameter of 0.6 mm. Insulator is positioned on and contacts with an outer peripheral surface of the first electrode 104 without forming a gap between the insulator and the first electrode 104, and thereby the metal is exposed only at the end face of the first electrode. The outer peripheral surface of the first electrode 104 does not contact with the to-be-treated water 110 directly owing to the disposition of the insulator on the outer peripheral surface of the electrode without gap. In the present embodiment, titanium oxide as the insulator was plasma-sprayed directly on the first electrode 104 and the thickness of the insulator was 0.1 mm. The titanium oxide is preferably used as the insulator when the treated liquid is used in life of person since the titanium oxide has less effect on the human body.

When the gas is continued to be supplied from the opening portion of the first electrode 104 in the to-be-treated water 110 using the above configuration, a bubble 106 is formed in the to-be-treated water 110. The bubble 106 is a columnar bubble having a dimension such that the gas within the bubble covers the opening portion of the first electrode 104, that is, the opening portion of the first electrode 104 is positioned within the bubble 106. Therefore, the first electrode 104 also functions as a bubble-generating part in the first embodiment. The end face of the opening portion of the first electrode 104 is not covered by the insulator 103 as shown in FIG. 1-2, and exposes metal. The state wherein the vicinity of the opening portion of the first electrode 104 is covered with the gas within the bubble 106 can be maintained by setting an amount of supplied gas with use of the pump 105. The insulator of titanium oxide is disposed on the outer peripheral surface of the first electrode 104. Therefore, it can be said that the surface of the first electrode 104 is constructed such that the state where the surface of the first electrode 104 does not contact directly with the to-be-treated water 110 can be achieved. When an appropriate amount of gas is continued to be supplied, the state is achieved where the surface of the first electrode 104 does not contact directly with the to-be-treated water 110, that is, the state is achieved where the conductor of the first electrode 104 is not exposed to the to-be-treated water 110.

In the present specification, “the first electrode (or the surface of the first electrode) does not contact directly with liquid (to-be-treated water)” means that the surface of the first electrode does not contact with liquid as a large mass in the treatment vessel. Therefore, when the bubble is generated from the bubble-generating part with the surface of the first electrode wet (strictly, with the surface of the first electrode in contact with the liquid), a state where the surface is covered with the gas within the bubble may be achieved. Such state is included in the state where “the first electrode does not contact directly with liquid.”

### [Operation]

Next, the operation of the liquid-treating apparatus of the present embodiment is described.

Firstly, the gas is supplied by the pump 105 into the to-be-treated water 110 from one opening portion of the first electrode 104 which portion is positioned in the treatment vessel. The flow rate of the gas is, for example, 0.5 litters/min to 2.0 litters/min. In the to-be-treated water 110, the columnar bubble 106 is formed such that the gas inside the bubble 106 covers the opening portion of the first electrode 104 as described above. The bubble 106 is a single and large bubble which is continuous over a certain distance (20 mm or more in the illustrated embodiment) from the opening portion of the first electrode 104. In other words, the supply of gas gives the state where the vicinity of the opening portion of the first electrode 104 is positioned within the bubble 106 and covered with the gas within the bubble 106. The bubble 106 of which internal gas covers the end face of the opening portion of the first electrode 104 is defined in the liquid by a gas-liquid interface which is not “close”, and contacts with the insulator 103 around the opening portion of the first electrode 104. As described above, the conductor is exposed only at the end face of the opening portion in the external surface of the first electrode 104, and therefore the external surface of the first electrode 104 is isolated from the to-be-treated water 110 by the bubble 106 and the insulator 103 as a result of generation of the bubble 106. The inside surface (inner peripheral surface) of the first electrode 104 is covered by the gas supplied during the formation of the gas 106 and does not contact directly with the to-be-treated water 110.

It is preferable that the vicinity of the opening portion of the first electrode 104 is positioned within the bubble 106, that is, continuously covered with the gas within the bubble 106 during the application of voltage between the first electrode 104 and the second electrode 102. However, when the supplied amount (flow rate) of the gas is small, and even if the gas is continuously supplied, the vicinity of the opening portion of the first electrode 104 may not be positioned within the bubble 106 resulting in direct contact with the to-be-treated water 110. The presence or absence of such contact can be observed by taking a photograph of the vicinity of the first electrode 104 every 0.1 ms to 0.5 ms during the supply of gas, using a high-speed camera. Further, it is possible to know a frequency of contact between the first electrode 104 and the liquid by taking photographs with use of a highly sensitive camera while the gas is supplied continuously for 1 seconds to 30 seconds, and determining an electrode coverage by the following formula. Whether the surface where the conductor is exposed, of the first electrode is positioned within the bubble or not is judged by visual observation of the photographs. The gas is supplied in the liquid-treating apparatus of the present invention including this embodiment such that the electrode coverage is preferably 90% or more, more preferably 94% or more.

Electrode coverage (%)=[(number of images (photographs) wherein the conductor-exposed surface of the first electrode is positioned within the bubble)/(total number of images (photographs) taken)]×100

Next, the voltage is applied between the first electrode 104 and the second electrode 102. The pulsed voltage is applied to the first electrode 104 with the second electrode 104 grounded. For example, a pulsed voltage has a peak voltage of 4 kV, a pulse duration of 1 μs and a frequency of 30 kHz. The power is, for example, 200 W. Plasma is generated in the vicinity of the first electrode 104 by the application of the voltage between the first electrode 104 and the second electrode 102. Although the plasma is spread over the entire of the bubble 106, concentrated plasma 107 is formed particularly in the vicinity of the first electrode 104. It is found that the plasma is also formed in the inside of the first electrode (the inner peripheral portion of the cylindrical first electrode) and not only the tip portion but the entire electrode is effectively used. Further, the observation by the high-speed camera shows a relatively smooth surface of the bubble as shown in FIG. 1-3 and it is considered that the shock wave due to the plasma is not generated.

The distance between the first electrode 104 and the second electrode 102 is not limited particularly. For example, it is not necessary to limit the electrode distance to 1 mm to 50 mm as described in Patent Document 1. The plasma can be generated even if the distance between the electrodes is more than 50 mm.

Further, the first electrode 104 and the second electrode 102 are not required to be opposed to each other. The position of the second electrode 102 is not limited as long as at least a part of the second electrode 102 contacts with the to-be-treated water 110 in the treatment vessel 109. This is because the entire to-be-treated water functions as an electrode as a result of contact of the second electrode 102 with the to-be-treated water 110. In other words, it is considered that the entire surface of the to-be-treated water 110 which contacts with the bubble 106 functions as the electrode when viewed from the first electrode 104.

Further, a frequency of the pulsed voltage is not limited particularly. For example, the plasma can be sufficiently generated by application of pulsed voltage of 1 Hz to 30 kHz. On the other hand, it is needless to say that the voltage is not determined only by the performance of the power supply, and it is determined by balance with the impedance of a load. There is an advantage that lifetime of the electrode is improved by applying a bipolar pulsed voltage, that is, by applying positive voltage and negative voltage alternately. In this embodiment, the power supply which is capable of outputting a voltage of 6 kV without a load is used, and a voltage of 4 kV can be applied actually, under the condition that the loads including the electrodes are connected thereto as described above. In this manner, the plasma can be formed with less loss of the voltage in the present embodiment.

In the present embodiment, the inner diameter of the first electrode 104 was 0.4 mm and the outer diameter was 0.6 mm. However, the plasma can be formed when the inner diameter is 0.07 mm to 2.0 mm and the outer diameter is 0.1 mm to 3.0 mm. Further, the dimension (the length) of the first electrodes 104 in the treatment vessel 109 is not limited particularly. For example, in the treatment vessel 109, the first electrode 104 having the inner and outer diameters of the above-mentioned ranges may have a length of 0.1 mm to 25 mm. In this embodiment, the length of the portion of the first electrode 104 which portion is positioned in the treatment vessel 109 is about 10 mm. When the portion of the first electrode 104 which portion is positioned in the treatment vessel 109 is small, the bubble 106 formed near the opening portion of the first electrode 104 cannot spread in a direction toward the wall of the treatment vessel 109 (collides with the wall) and thereby an area of a gas-liquid interface is small, resulting in tendency of reduction in the plasma generation amount. However, plasma is generated as long as the first electrode 104 is positioned in the treatment vessel 109. In this way, tolerance for the size of the electrodes is also wide in the liquid-treating apparatus of the present embodiment.

### [Effect (OH Radical Generation)]

FIG. 2 is a graph showing the results of measuring the emission characteristics of the plasma in the present embodiment by a spectrometer. The results are obtained in the case where the tap water is employed as the to-be-treated water 110, the water temperature is 26.5° C. and the conductivity is 20.3 mS/m. As shown in FIG. 2, light emission due to OH radicals generated by the decomposition of water is observed. In addition, the light emissions of N₂, N, H and O are observed. Emissions of N₂ and N are due to the supply of air as the gas in the to-be-treated water 110. In this manner, the plasma having the characteristics of both plasma formed in water and plasma formed in the air, is generated in the present embodiment.

### [Effect (Decomposition Speed)]

Then, the effect on the to-be-treated liquid given by the liquid-treating apparatus of the present embodiment will be described. In the present embodiment, an aqueous indigocarmine solution was used as the model of the to-be-treated liquid. Indigocarmine is a water-soluble organic substance, and is often used as a model for polluted-water treatment. A concentration of the aqueous indigocarmine solution used in the present embodiment was 10 mg/liter, and the volume of the to-be-treated water 110 was 250 milliliters.

As described above, OH radicals, N radicals, N₂ radicals, H radicals and O radicals are generated in the present embodiment. These radicals acts on indigocarmine and cut the binding in the molecule to decompose the indigocarmine molecule. As is generally known, an oxidation potential of the OH radical is 2.81 eV, being greater than those of ozone and chlorine. Thus, the OH radicals can decompose not only indigocarmine, but many organic substances. In addition, the bond energies between the O radical and carbon and between the N radical and carbon are 1076 kJ/mol and 750 kJ/mol respectively, being much larger than the C—C bond energy of 618 kJ/mol and the C—H bond energy of 338 kJ/mol. Therefore, they contribute significantly to the decomposition of indigocarmine molecules. Further, N ions and N₂ ions are generated by the plasma due to the generation of the bubble 106 by air supply, and these ions collide with indigocarmine molecules. Since the collision of these ions weakens the inter-molecule bond of the indigocarmine molecule, the decomposition effects of the OH radicals, the O radicals, and N radicals are made much larger.

The decomposition degree of the indigocarmine molecule can be evaluated by absorbance of an aqueous solution thereof. It is generally known that blue of the aqueous indigocarmine solution is decolorized when the indigocarmine molecules are decomposed and the solution become transparent when the molecules are decomposed completely. This is because the absorption wavelength of the carbon double bond (C═C) is 608.2 nm and the C═C bond is cleaved by the decomposition of the indigocarmine molecule whereby light of 608.2 nm is not absorbed. Thus, the degree of decomposition of the indigocarmine molecules was evaluated by measuring the absorbance of light having a wavelength of 608.2 nm using an ultraviolet-visible light spectrophotometer.

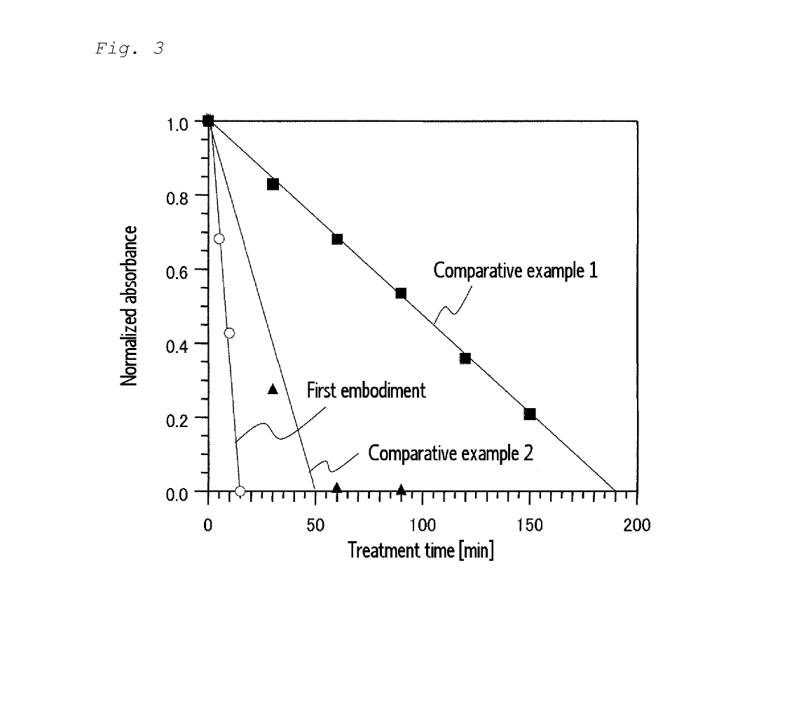

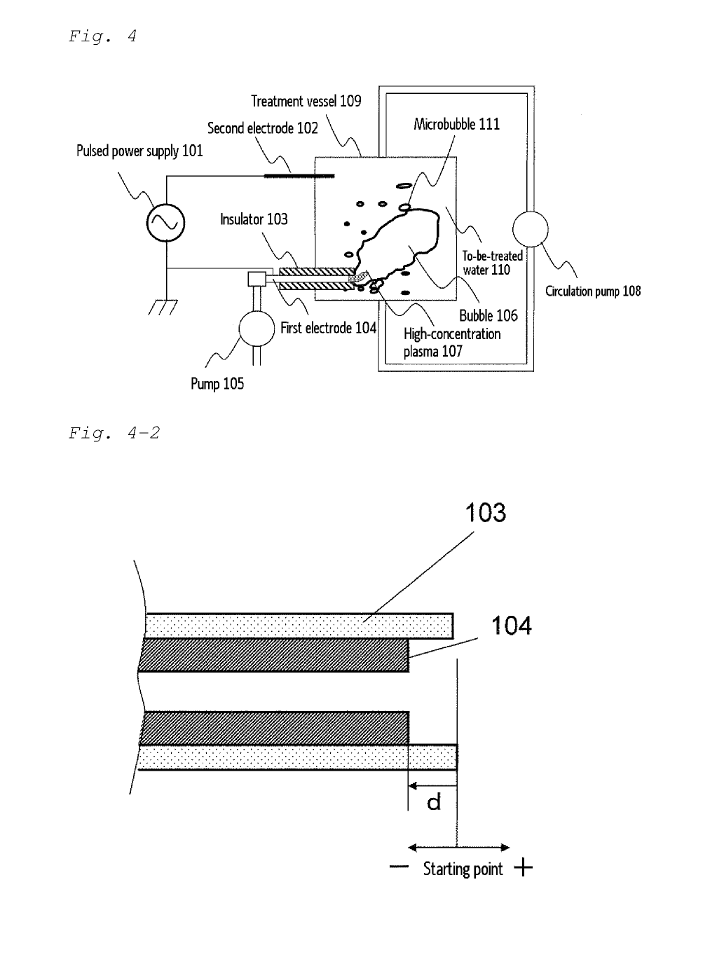

In FIG. 3, the results of measuring the change in absorbance of the aqueous indigocarmine solution relative to the treated time are shown in a graph. The values of absorbance in FIG. 3 are ones normalized assuming that the absorbance of the untreated solution is 1. In FIG. 3, open circles show the results given by the liquid-treating apparatus of the present embodiment. In addition, as Comparative Examples 1 and 2, the results given by the conventional liquid-treating apparatuses are shown by black triangles and black squares.

In the conventional liquid-treating apparatus of Comparative Example 1, columnar electrodes of tungsten having an outer diameter of 0.16 mm were used as the first electrode 104 and the second electrode 102 and the end faces of these electrodes was opposed to each other with a distance of 2 mm in the indigocarmine solution. The results of treatment by this apparatus are shown by the black squares. Further, the black triangles show, as Comparative Example 2, the change in absorbance during the treatment wherein the same electrode configuration was employed and fine bubbles (diameter of about 0.3 mm) were continuously supplied between the first electrode 104 and the second electrode 102 from a nozzle provided separately. In these comparative examples, the power supplied to the first electrode 104 was set to 200 W similarly to the liquid-treating apparatus of the present embodiment.

As shown in FIG. 3, the liquid-treating apparatus of the present embodiment was able to decompose the aqueous indigocarmine solution almost completely within about 16 minutes. This was achieved by generating the OH radicals efficiently. On the other hand, in Comparative Example 1, it took 190 minutes to decompose the aqueous indigocarmine solution almost completely. Further, it took 50 minutes even in Comparative Example 2 wherein the bubbles were interposed between the electrodes. Thus, according to the liquid-treating apparatus according to the present embodiment, it is possible to generate plasma efficiently with the same input power and to treat the liquid in a short period of time.

Consideration of the conventional liquid-treating apparatuses as the comparative examples is as follows. It is considered that, in Comparative Example 1 wherein two electrodes are opposed with a distance of 2 mm, the amount of generated radicals is small since the plasma is generated in space of about 0.04 mm³ between the electrodes. According to the detailed analysis of the inventors, it is found that bubbles are generated near the surfaces of the two opposed electrodes during the discharge in Comparative Example 1, and the plasma is generated inside the bubbles. Moreover, the bubbles are not always formed. When the bubbles are moved by buoyancy, the plasma is accordingly extinguished. Then, the formation of fresh bubbles and the generation of plasma inside the bubbles are repeated. That is, although it is possible to generate plasma by narrowing the distance between the electrodes and applying pulsed voltage, the plasma is not efficiently generated because of the intermittent generation of plasma and a small space in which the plasma is generated. For this reason, the decomposition time of the indigocarmine molecules is considered to be longer.

In the case where the bubbles are supplied through a nozzle from the outside, more bubbles are continuously interposed between the electrodes. Therefore, it is considered that more plasma is generated compared to the case where the bubbles are not supplied. However, the liquid-treating apparatus of the present embodiment can generate more plasma compared to the case where the bubbles are supplied from the outside, and gives pronounced effect of reducing the time for decomposing indigocarmine molecules to one third. It is considered that this is because the gas is continuously supplied to the to-be-treated water 110 at a relatively large flow rate from the end portion of the first electrode 104. That is, it is considered that this is because the end face of the surface of the first electrode 104 which surface is positioned in the liquid (the conductor-exposed surface) is covered with the gas within the bubble 106 by the supply of a large amount of gas during the discharge between the first electrode 104 and the second electrode 102, whereby the first electrode 104 does not contact directly with the to-be-treated water 110. It is considered that, as a result, a current path (or discharge path) consisting of only liquid is not formed in the treatment vessel, whereby a high voltage is applied to the gas-liquid interface without loss of voltage, leading to generation of much plasma. Detail will be described in a second embodiment.

In this embodiment, iron was used as a material for the second electrode 102 and the first electrode 104. These electrodes may be formed of tungsten, copper or aluminum or the like. Further, the insulator provided on the outer peripheral surface of the first electrode 104 may be formed by thermally spraying yttrium oxide. Yttrium oxide has higher resistance against plasma compared to titanium oxide. Therefore, the use of yttrium oxide gives the effect of increasing the electrode lifetime.

[Effect (Treatment with a Low Power)]

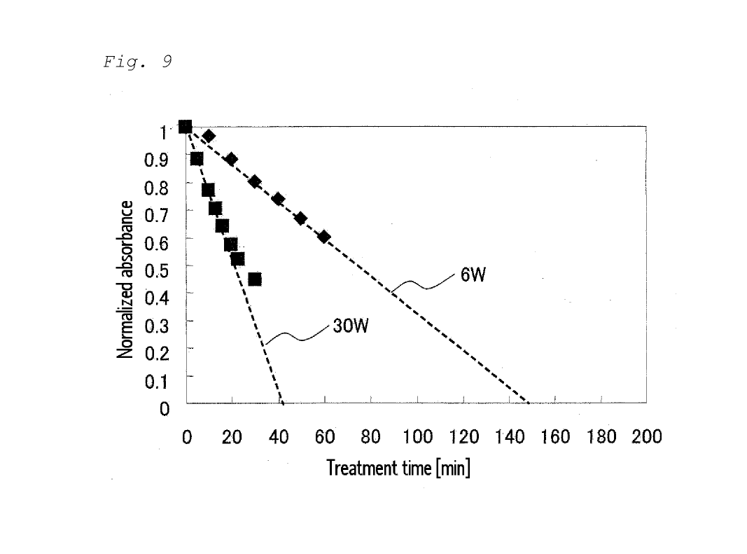

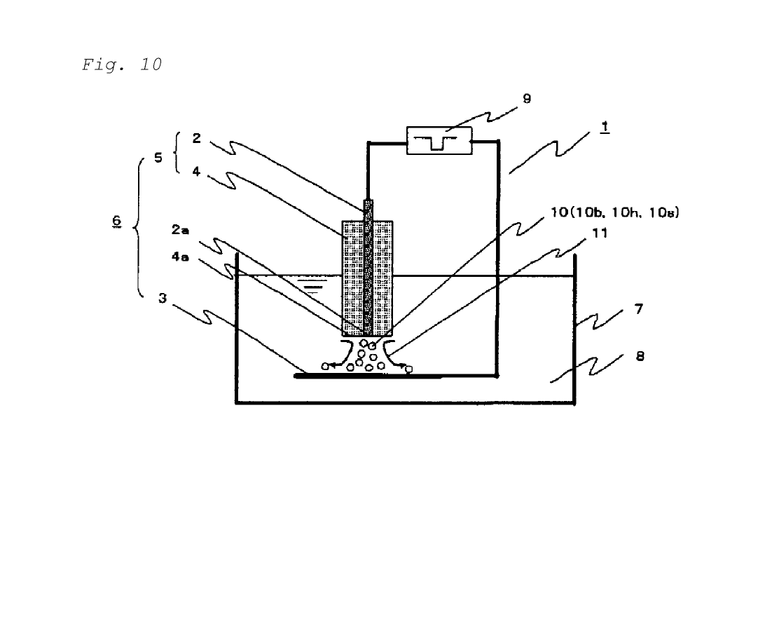

In the present embodiment, the change in time required for decolorizing blue of the aqueous indigocarmine solution was observed while the supplied power was varied. The flow rate was set to 2000 ml/min in the liquid-treating apparatus of the configuration as described above. Further, pulsed voltage having a peak voltage of 4 kV, a pulse duration of 500 μs, a frequency of 100 Hz and a power of 30 W was applied between the first electrode 104 and the second electrode 102, and the time required for decomposing the indigocarmine molecules in the aqueous solution was determined. Similarly, pulsed voltage having a pulse duration of 500 μs, a frequency of 100 Hz and a power of 6 W was applied between the first electrode 104 and the second electrode 102, and the time required for decomposing the indigocarmine molecules in the aqueous solution was determined. The results are shown in FIG. 9. A power supply of a different specification was used in order to reduce the set value of the power.

As shown in FIG. 9, as the power was smaller, the time required for decomposition was longer. However, the plasma was generated and the decomposition proceeded even when the power was about 30 W or 6 W. It is presumed that the time required for decomposition of all the indigocarmine molecules in the aqueous solution is 150 minutes when the power is 6 W, and this presumed time is shorter than the time required in Comparative Example 1 wherein the power was 200 W.

Further, when 30 W or 6 W was tried to be supplied in the treating apparatus of the configuration used in Comparative Example 1, the flash boiling phenomenon was not observed and the discharge did not occur since the power was not able to be input at all (6 W and 30 W was not able to be set), resulting in failure or plasma generation.

The liquid-treating apparatus of the present invention enables the liquid to be treated with a small power. Accordingly, the liquid-treating apparatus of the present invention does not require high power (4000 W or more) such as required in the apparatuses described in Patent Document 1 and Patent Dcoument 6. Specifically, the power supply may be one of which maximum output capacity is more than 0 W and less than 1000 W in the liquid-treating apparatus of the present invention and the power over 1000 W is not required to be supplied. Such power can be obtained from the power supply of the household electric appliance. Thus, the liquid-treating apparatus according to the present invention is suitable for being incorporated into a household electric appliance in terms of power, and the unit consisting of the power supply and the pump can be made so small that it has the above-mentioned volume (1000 cm³ to 5000 cm³).

Further, in the case where the power of the above-mentioned range is supplied, the discharge between the electrodes is corona to glow discharge. When the plasma is generated by the glow discharge, the power consumption is lower compared with abnormal glow discharge and arc discharge and a large current is not required, and therefore the capacity of the power supply is made smaller and the deterioration of the electrode is reduced. For these reasons, there is an advantage that the price of the apparatus and the maintenance cost are reduced.

### [Reference Embodiment]

A plasma-generating method is known wherein an electrode to which voltage is applied is not positioned in liquid and is positioned above a liquid level, a grounding electrode is positioned in the liquid, and plasma is generated on the liquid level by conducting discharge. This method and the present invention are in common in that the electrode to which voltage is applied is not in direct contact with the liquid. However, when the plasma is generated according to this method, ozone is generated. Ozone is an undesirable product. Further, in this method, there is a tendency that the area of the plasma in contact with the liquid becomes smaller, resulting in generation of a small amount of OH-radical. Further, there is a limit to the increase in the amount of the generated OH radical by increasing the number of the electrodes. This is because, even if a plurality of electrodes are arranged to increase the area of plasma, the distance between the electrode and the liquid level is narrow to be about 1 mm and the volume of plasma generated in the space therebetween is small, and the interface between the plasma and the water is thin. In addition, there is also a drawback that this method is difficult to be employed in a home appliance wherein the liquid level changes. The time for decolorization was about 45 minutes in experiment wherein 250 milliliters aqueous indigocarmine solution of 10 mg/L was treated applying power of 200W with use of an electrode having a diameter of 1 mm. It is considered that this means that this method is poor in sterilization efficiency compared to the discharge obtained by using the liquid-treating apparatus of the present invention. In addition, when the power is 30 W or 6 W, the decolorization speed is too slow to determine.

### Second Embodiment

### [Detailed Discussion of Electrode Configuration]

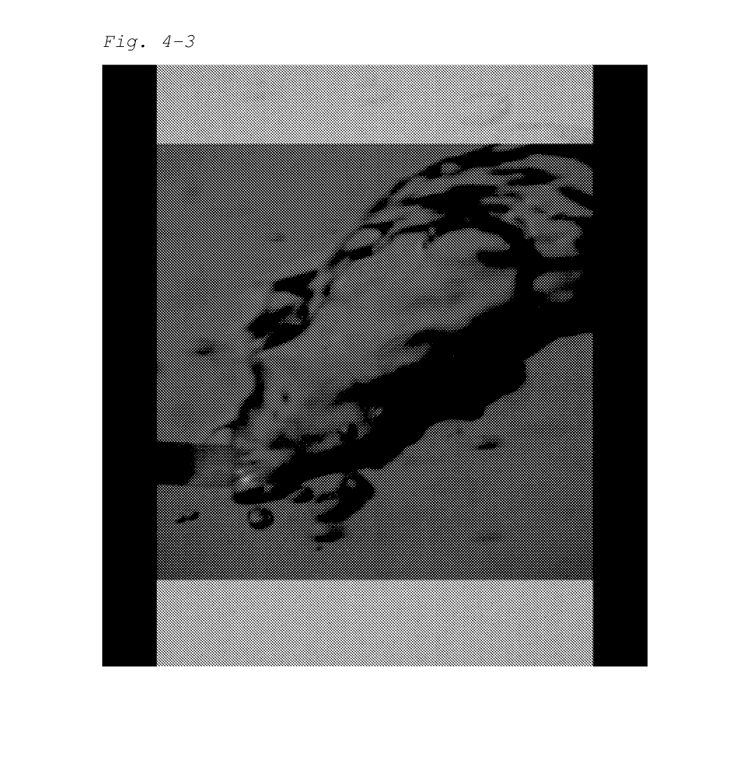

FIG. 4 is a diagram showing the overall configuration of a liquid-treating apparatus according to the present embodiment. The present embodiment is different from the first embodiment in that alumina ceramics of cylindrical shape is used as an insulator 103. The other structure is the same as that of the first embodiment.

FIG. 4-2 is an enlarged view of the vicinity of the opening portion of the first electrode 104. An alumina ceramic insulator 103 of cylindrical shape having an inner diameter of 0.6 mm and an outer diameter of 0.9 mm is disposed on and in closely contact with the outer peripheral surface of the first electrode 104. The insulator 103 is configured to be slidable relative to the first electrode 104. In the present embodiment, the positional relationship between the end face of the first electrode 104 and the end face of the insulator 103 is changed and the influence of this change on the treatment time of the to-be-treated liquid is examined. As shown in FIG. 4-2, the distance between the tip of the first electrode 104 and the tip of the insulator 103 is defined as “d”, and “d” is represented by a positive value, when the tip of the first electrode 104 is protruded from the tip position of the insulator 103 as a base position, and “d” is represented by a negative value when the tip of the first electrode 104 is retracted inwardly.

Air of 2000 ml/min was supplied from the pump. Further, the second electrode 102 was grounded and pulsed voltage having a peak voltage of 4 kV, a pulse duration of 1 μs, a frequency of 30 kHz and a power of 200 W was applied to the first electrode 104.

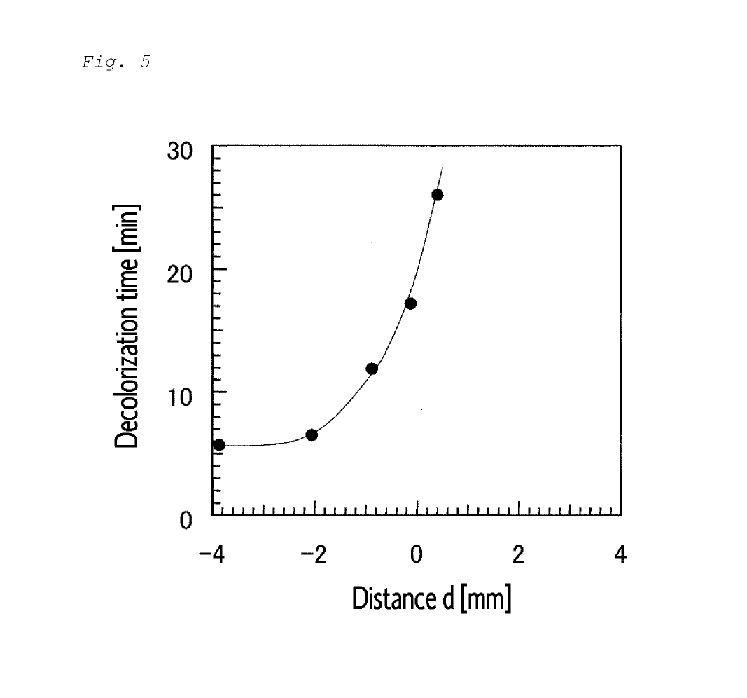

The graph of FIG. 5 shows relationship between time required for complete decolorization of an aqueous indigocarmine solution and the distance “d”. As show in FIG. 5, it is understood that, as the distance “d” is changed from a positive value to a negative value, the decolorization time is shortened quickly and the decomposition of indigocarmine makes progress. In particular, the decolorization time is significantly reduced when the distance “d” is changed from a positive value to −2 mm. This is because the tip of the first electrode 104 is more likely to be covered by the supplied air as a result of retraction of the tip of the first electrode 104 from the tip of the the insulator 103. When the tip portion of the first electrode 104 is covered with the gas, the first electrode 104 is not in direct contact with the to-be-treated water 110 since the bubble 106 and the insulator 103 are interposed between the first electrode 104 and the to-be-treated water 110. As a result, no current path consisting only of the to-be-treated water 110 exist between the first electrode 104 and the second electrode 102. Therefore, the pulsed voltage applied to the first electrode 104 is applied to the bubble 106 without leaking to the to-be-treated water 110, resulting in efficient generation of plasma.

The decolorization time is not so changed, when the distance “d” is −2 mm or less. Further, when the distance “d” is −4 mm or less, the length of the interface between the gas and the water is rather long to make discharge difficult. Therefore, the plasma is difficult to decompose water, resulting in reduction in amount of the OH radicals. Thus, this is not to say that it is favorable that the end face of the first electrode 104 is simply farther away from the to-be-treated water 110. The optimal distance “d” depends on the amount of gas supplied and the dimension and shape of the first electrode.

Further, in the case where the position of the end face of the opening portion of the first electrode was positioned outside the end face of the insulator at the start of the voltage application and was moved relatively more inside than the end face of the insulator after the generation of plasma, the decolorization time was not long even if the distance “d” after the movement was −4 mm or less. It is considered that this is because the plasma generation was started in the state where the opening portion of the first electrode 104 was positioned within the bubble 106 and covered with the gas in the bubble 106 that was formed in the to-be-treated water 110. That is, it is considered that this is because the volume of the plasma protruded in the water when “d” was changed to −4 mm or less after the generation of the plasma, was not changed from the volume of the plasma protruded in the water when “d” was −2 mm, and therefore the amount of the radicals was not so changed.

Further, when the first electrode 104 is moved relatively to the insulator 103 to obtain a minus value of “d”, there is an advantage of stable discharge with a small and stable voltage loss since the first electrode 104 is hardly wet by water. The relative movement of the first electrode 104 to the insulator 103 may be performed by moving the insulator 103, or by moving the first electrode 104.

The bubble state was observed with a high-speed camera while varying the distance “d”. As shown in FIG. 4-3, when “d” is −2 mm, the surface of the bubble is less smooth compared to the first embodiment shown in FIG. 1 and many convexities and concavities are generated in the surface due to the shock wave caused by the plasma. Further, a part of the bubble is separated by the shock wave at the same time and thereby micro bubbles 111 are generated. This is due to the fact that the end face of the first electrode 104 is away from the to-be-treated water 110 and thereby a higher voltage is applied to the interface between the gas and the liquid in a moment.

### Third Embodiment

### [Overall Configuration]

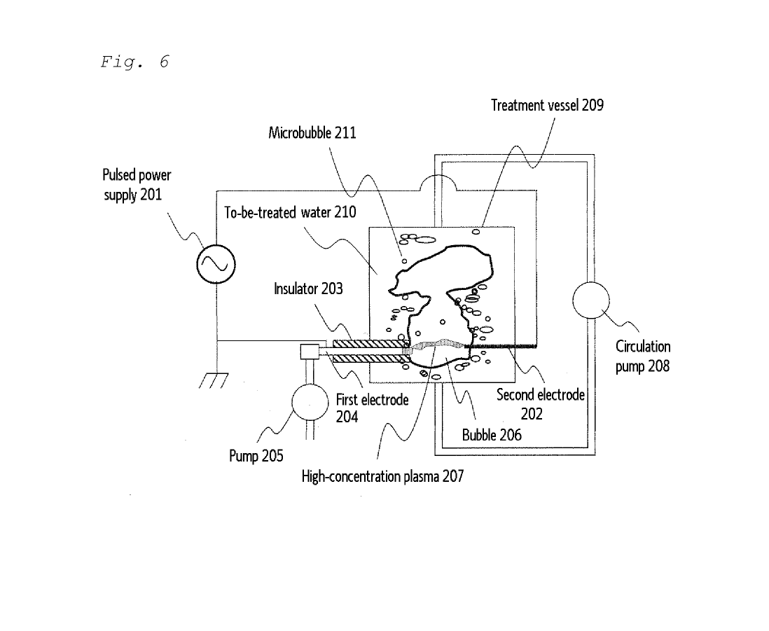

FIG. 6 is a configurational view of a liquid-treating apparatus of the present embodiment. In the present embodiment, the configuration is made such that a part of the second electrode 202 contacts with a bubble 206 or a part of the second electrode 202 is positioned within the bubble 206. The other configuration is the same as the first embodiment. In FIG. 6, a numeral having the same last two digits as those of the numeral in FIG. 1 denotes the same element or member denoted by the numeral in FIG. 1.

Air of 2000 ml/min was supplied from the pump. Further, the second electrode 202 was grounded and pulsed voltage having a peak voltage of 4 kV, a pulse duration of 1 μs, a frequency of 30 kHz and a power of 200 W is applied to the first electrode 204.

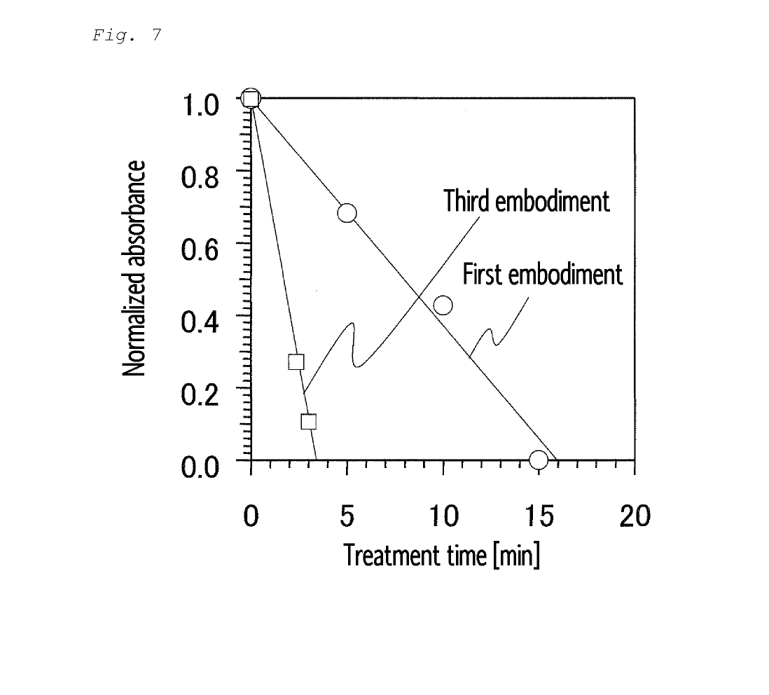

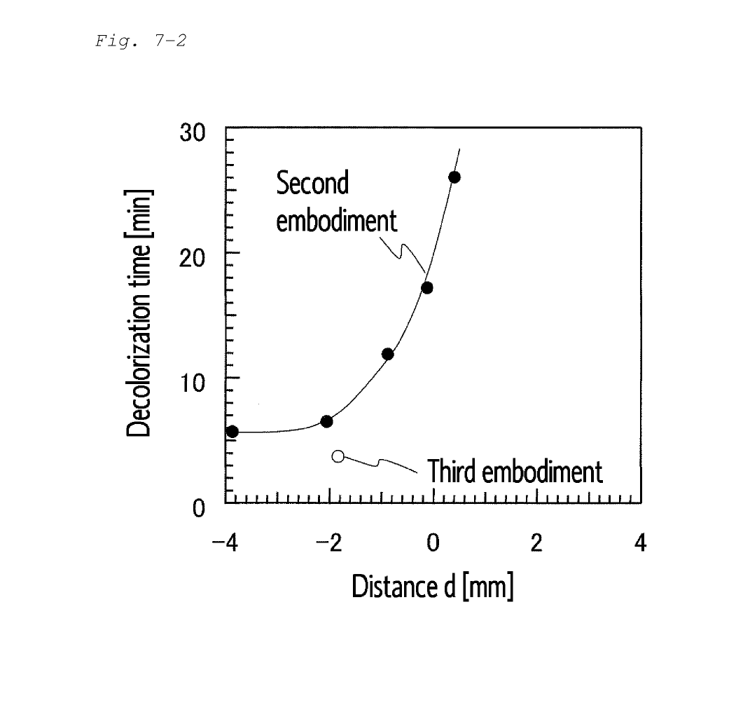

In the present embodiment, the state of bubble was observed with a high-speed camera. As shown in FIG. 7-3, the surface of the bubble 206 is not smooth and many convexities and concavities are generated in the surface due to the shock wave caused by the plasma. Further, a part of the bubble is separated by the shock wave at the same time and thereby micro bubbles 211 are generated. In comparison with the first embodiment shown in FIG. 1, the number of microbubbles generated is overwhelmingly large.

### [Effect]

FIG. 7 is a graph showing the results of measurement of change in absorbance of an aqueous indigocarmine solution to the treatment time in the present embodiment. In FIG. 7, open squares are measurement results for the present embodiment. Further, white circles are measurement results for the first embodiment. Power of 200 W was supplied between each of the first electrodes 204, 104 and each of the second electrode 202, 102.

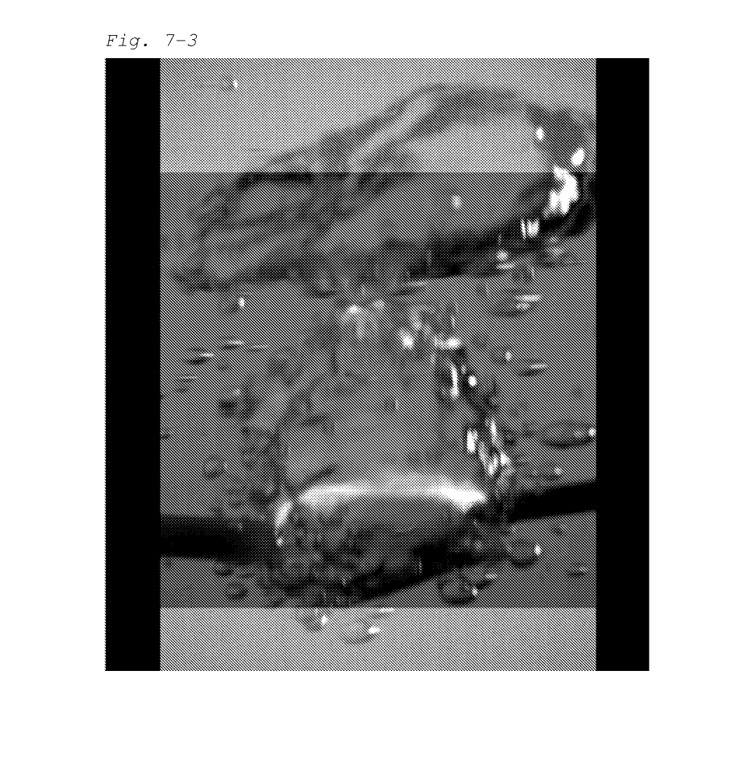

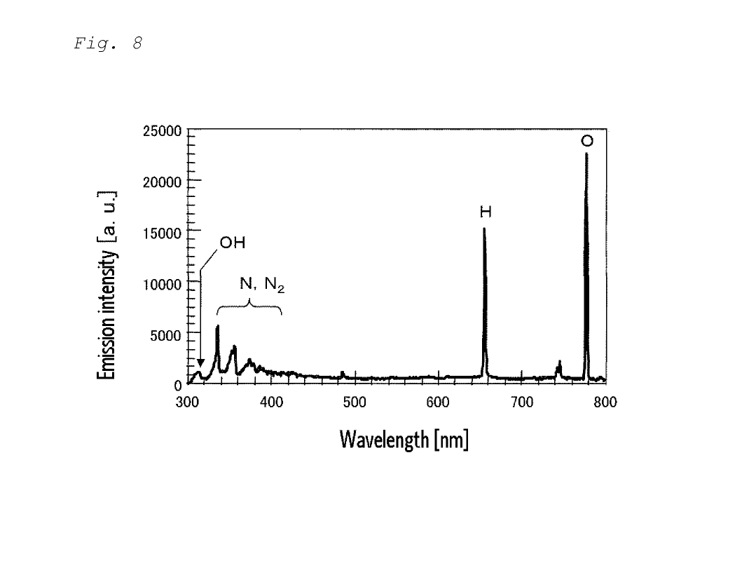

As shown in FIG. 7, the time required for decomposing the aqueous indigocarmine solution completely in the present embodiment was 3 minutes and 30 seconds. On the other hand, the time required for decomposing the aqueous indigocarmine solution in the first embodiment was about 16 minutes. That is, it is found that the configuration of the present embodiment can reduce the treatment time to a quarter or less of the treatment time required in the configuration of the first embodiment. This is because the voltage is not lost (that is, the current does not escape in the liquid) and higher voltage is applied to the gas inside the bubble as well as to the interface between the bubble and the solution due to the fact that the electrode 202 is in contact with or positioned in the bubble. Accordingly, a higher plasma density is obtained and more O and H radicals are generated, whereby the treatment is completed in a short time, as shown in FIG. 8. Furthermore, a shock wave generated by strong electric field acts on the interface between the bubble and the solution to separate a part of the bubble, resulting in generation of microbubbles. Since the microbubbles contain the OH radicals and the O radicals and these radicals are diffused over the entire solution by the micro-bubbles, the decomposition of the indigocarmine is further prompted. In this manner, the present embodiment can conduct the degradation of microorganism and bacteria efficiently by utilizing the shock wave.

Further, in a variation of the present embodiment, the influence on the treatment time of the to-be-treated liquid was observed by using the insulator 203 of cylindrical alumina ceramics which is movable relative to the electrode 204 and changing the positional relationship between the end face of the first electrode 204 and the end face of the insulator 203 similarly to the second embodiment. In this variation, the end face of the first electrode 204 is positioned about 2 mm inwardly from the end face of the insulator 203, and the absorbance of the to-be-treated liquid is determined while the plasma is generated.

The results are shown in FIG. 7-2. It is found that the variation of this embodiment further shortened the decolorization time compared to the second embodiment as shown in FIG. 7-2. From this result, it can be said that the voltage is not lost and higher voltage is applied to the gas inside the bubble and to the interface between the bubble and the solution, due to the fact that the second electrode 202 is in contact with or placed within the bubble.

The present embodiment has been described as the embodiments, but the present invention shall not be limited to the embodiments described above. In the above embodiments, the embodiment wherein the to-be-treated liquid is water has been described as an example and the embodiment wherein the aqueous indigocarmine solution is used as a model has been described. The same effects can be obtained even if the liquid is alcohol, sea water, or an aqueous solution wherein a chemical is dissolved.

In the above embodiment, a technique of generating the bubble has been described wherein the first electrode is made tubular (more specifically, cylindrical) and the gas is supplied by the gas supplying apparatus to the first electrode so as to supply the gas through the opening portion of the first electrode into the liquid. In another embodiment, the bubble-generating part may be provided independently from the first electrode. The bubble-generating part generates a bubble such that the surface where the conductor is exposed, of the surface of the first electrode which surface is positioned in the liquid, is covered by the gas within the bubble, that is, the surface where the conductor is exposed is positioned within the bubble. Such a bubble is formed by appropriately selecting a flow rate of the gas sent to the bubble-generating part, a size of the bubble-generating part (for example, an inner diameter of the bubble-generating part if the bubble-generating part is cylindrical) and the position of the bubble-generating part. When the gas-generating part is placed under the first electrode, the gas in the bubble easily covers the surface of the first electrode since the bubble formed in the liquid moves from bottom to top by buoyancy.

In the embodiments described above, the first electrode is made tubular and the outer peripheral surface of the first electrode is covered with insulator such that the outer peripheral surface of the first electrode is not exposed to the liquid. Therefore, the area to be covered by the gas in the bubble is only the vicinity of the opening portion (end face) of the first electrode. Therefore, the effect of the present invention can be obtained relatively with ease by using the first electrode of such configuration. In another embodiment of the present invention, the first electrode may not be covered with the insulator. In this case, the gas-generating part is provided such that the entire of the surface portion of the first electrode which portion is positioned within the liquid is covered with the gas. Alternatively, in another embodiment, the insulator may cover a part of the outer peripheral surface of the first electrode. In this case, the surface portion of the first electrode, which portion is not covered with the insulator, is required to be covered with the gas within the bubble.

In the above embodiments, a circulation pump for circulating the to-be-treated water is provided. The circulation pump is not necessarily needed. In the plasma-generating apparatus according to the present invention, the generation of bubble causes the circulation of the liquid naturally in the treatment vessel and the circulation of the liquid is also facilitated by the generation of microbubbles. Thus, the entire to-be-treated water can be treated by plasma even if the circulation pump is not provided.

In the embodiments described above and other embodiments, a film for preventing the electrode from corroding may be formed on the first electrode. The corrosion protection film is formed by selecting material and thickness in consideration of the material for electrode and the voltage applied to the electrode, such that the discharge between the first electrode and the second electrode is not hindered. The effect of the present invention can be obtained even if such a film is formed on the conductor surface of the first electrode and the embodiment having such a film is covered by the claims of the present application.

The liquid-treating apparatus of the present invention is suitable for: liquid treatment by decomposition of the chemical presenting in the liquid, the destruction of microorganism or sterilization or the like, and can be used together with various products, particularly electrical products, or can be used being incorporated into electrical products. The electrical products include water purification apparatuses, air conditioners, humidifiers, ballast water treatment systems for ships, washing machines for electric razors, washing machines and dishwashers. The water purification apparatuses, the air conditioners, the humidifiers, the washing machines for electric razors and dishwashers may be for home use. The liquid-treating apparatus of the present invention can be operated using a power supply for a household appliance since the apparatuses can treat the liquid with a low power.

### INDUSTRIAL APPLICABILITY

The liquid-treating apparatus of the embodiment of the present invention is useful as a water purification apparatus and so on for, for example, waste water treatment and so on.

### REFERENCE NUMERALS

101, 201 Pulsed power supply

102, 202 Second electrode

103, 203 Insulator

104, 204 First electrode

105, 205 Pump

106, 206 Bubble

107, 207 High-concentration plasma

108, 208 Circulation pump

109, 209 Treatment vessel

110, 210 To-be-treated water

111, 211 Microbubble

1-15. (canceled)

16. A liquid-treating apparatus comprising:
a first electrode of which at least a part is placed in a treatment vessel that is to contain liquid,
a second electrode of which at least a part is placed in the treatment vessel,
a gas-supplying apparatus which supplies gas from the outside of the treatment vessel,
a bubble-generating part which supplies, into the liquid, the gas supplied by the gas-supplying apparatus and generates a bubble in the liquid when the liquid is contained in the treatment vessel, and
a power supply which applies voltage between the first electrode and the second electrode,
wherein the bubble-generating part generates the bubble such that at least surface where conductor is exposed, of a surface of the first electrode which surface is positioned in the treatment vessel, is positioned within the bubble formed of the gas supplied by the gas-supplying apparatus, and
the power supply applies power between the first electrode and the second electrode when the at least surface where the conductor is exposed, of the surface of the first electrode which surface is positioned in the treatment vessel, is positioned within the bubble, to cause plasma generation.

17. The liquid-treating apparatus according to claim 16, wherein a maximum value of the output capacity of the power supply is more than 0 W and less than 1000 W.

18. The liquid-treating apparatus according to claim 16 wherein,
the first electrode is of a hollow shape having an opening portion,
insulator is positioned in contact with an outer peripheral surface of the first electrode,
the bubble-generating part generates the bubble from the opening portion of the first electrode,
the bubble-generating part generates the bubble such that surface where the insulator is not positioned and the conductor is exposed, of the surface of the first electrode which surface is positioned in the treatment vessel, is positioned within the bubble.

19. The liquid-treating apparatus according to claim 18, wherein an end face of the opening portion of the first electrode is positioned inwardly from an end face of the insulator.

20. The liquid-treating apparatus according to claim 18, wherein,
the insulator is of a hollow shape having an opening portion, and
the first electrode is movable relatively to the insulator.

21. The liquid-treating apparatus according to claim 16, wherein the power supply applies a pulsed voltage.

22. The liquid-treating apparatus according to claim 16, wherein the power supply applies an alternating voltage.

23. The liquid-treating apparatus according to claim 16, wherein the bubble-generating part generates the bubble such that a part of a surface of the second electrode contacts with the liquid and another portion of the surface of the second electrode contacts with the bubble or is positioned within the bubble.

24. The liquid-treating apparatus according to claim 16, wherein the gas-supplying apparatus is a pump.

25. An electric appliance which comprises the liquid-treating apparatus according to claim 16, and supplies the liquid treated by the liquid-treating apparatus or conducts another treatment using the liquid treated by the liquid-treating apparatus.

26. The electric appliance according to claim 25, which is a water purification apparatus, an air conditioner, a humidifier, a washing machine, a washing machine for electric razor or a dishwasher.

27. A method for treating liquid comprising:
applying voltage, using a power supply, between a first electrode and a second electrode using a power supply, at least a part of the first electrode being positioned in liquid contained in a treatment vessel and at least a part of the second electrode being positioned in the liquid,
supplying gas by a gas-supplying apparatus from the outside of the treatment vessel to a bubble-generating part positioned in the liquid, and
generating bubble of the gas supplied from the outside of the treatment vessel, such that at least surface where conductor is exposed, of a surface of the first electrode which surface is positioned in the liquid, is positioned within the bubble,
wherein plasma is generated by the application of voltage, when the at least surface where the conductor is exposed, of the surface of the first electrode which surface is positioned in the liquid, is positioned within the bubble.

28. The method for treating liquid according to claim 27, wherein the power supply supplies power of more than 0 W and less than 1000 W.

29. The method for treating liquid according to claim 27, wherein,
the first electrode is of a hollow shape having an opening portion,
insulator is positioned in contact with outer peripheral surface of the first electrode,
the insulator is of a hollow shape having an opening portion, and
the first electrode is configured to be movable relatively to the insulator,
which method further comprises moving an end face of the opening portion of the first electrode is moved inwardly from an end face of the opening portion of the insulator.

30. The method for treating liquid according to claim 27, wherein the bubble is generated such that at least a part of surface of the second electrode contacts with the liquid, and another part of the surface of the second electrode contacts with the bubble or is positioned within the bubble.

31. The liquid-treating apparatus according to claim 16, wherein the gas-supplying apparatus is set so as to supply the gas at a flow rate necessary for the bubble-generating part to generate the bubble such that the at least surface where conductor is exposed, of the surface of the first electrode which surface is positioned in the treatment vessel, is positioned within the bubble.

32. The method for treating liquid according to claim 27, wherein the gas is supplied at a flow rate necessary for the gas-generating part to generate the bubble such that the at least surface where conductor is exposed, of the surface of the first electrode which surface is positioned in the liquid, is positioned within the bubble.
